(19) United States
(12) Patent Application Publication
(10) Pub. No.: US 2013/0341285 A1
(43) Pub. Date: Dec. 26, 2013

(54) ASSURING THRESHOLD OZONE CONCENTRATION IN WATER DELIVERED TO AN EXIT POINT

(71) Applicant: Chadwick D. Marion, Neosho, MO (US)

(72) Inventor: Chadwick D. Marion, Neosho, MO (US)

(21) Appl. No.: 13/533,009

(22) Filed: Jun. 26, 2012

(51) Int. Cl. C02F 1/78

(52) U.S. Cl. 210/743; 210/96.1; 210/760; 210/746; 210/85

(57) ABSTRACT

A system delivers water with at least a threshold concentration of ozone to an exit point. Ozone is injected into water flowing into a tank. The ozone concentration in the tank is monitored by a first sensor. Once the water in the tank has at least the threshold concentration of ozone, the water may be pumped to an exit point. A second sensor in proximity to the exit point monitors the ozone concentration of the treated water in proximity to the exit point. If the water in proximity to the exit point has at least the threshold concentration of ozone, the system allows a portion of the treated water to exit the system to a point of use. The second sensor in proximity to the exit point assures the treated water that is actually delivered to the exit point has at least the threshold value of ozone concentration.

### BACKGROUND

1. Technical Field

This disclosure generally relates to treating water with ozone, and more specifically relates to assuring specific concentrations of ozone when the treated water is delivered to an exit point of the system.

2. Background Art

For over a hundred years people have been injecting ozone into water. Ozone is three atoms of oxygen bound together instead of the normal two. The extra oxygen atom causes ozone to be highly reactive. The extra oxygen atom very easily leaves the ozone molecule to oxidize whatever comes in contact with the water The oxidation process destroys bacteria, viruses, algae, fungi, and even cancer cells. When ozone is injected in water at a high enough concentration, the ozone completely purifies the water. If the ozone concentration in the water is high enough, the ozone can purify not only the water, but whatever the water touches. Water with high enough concentrations of ozone can become a disinfectant or a sterilant. Disinfecting and sterilizing with water treated with ozone are very effective and environmentally friendly. There are no harsh chemicals involved, and the only byproducts are oxygen and the oxidized contaminant.

The problem with water treated with ozone is ozone quickly decomposes in water. The half-life of ozone in water depends largely on the temperature of the water. At room temperature the half-life of ozone is 15-20 minutes. Thus for water treated with ozone to have any practical application, the treated water must be produced near where the treated water is needed. Known ozone water treatment systems have a sensor inside a tank to assure the water in the tank has a high enough concentration of ozone to perform the desired function (purify the water, disinfect, sterilize, etc.). However, the treated water must travel through a pipe or a hose to get the treated water to a point of use where it will actually be used. Because of the extremely short half-life of ozone, it is possible that the concentration of ozone in the water between the tank and the point of use may drop below the threshold required to perform the desired function. If the ozone level drops below the threshold for the desired function, that function will not be performed. IN many applications, this is unacceptable. One solution would be to put an ozone generator right next to each end use. This is impractical in almost any setting with multiple uses, and even in some settings with a single use, because the generator often cannot be placed near the end use due to cost, space restrictions, etc. A way is needed to assure the treated water as actually delivered to an exit point has the required ozone concentration level to perform the desired function.

### BRIEF SUMMARY

A system delivers water with at least a threshold concentration of ozone to an exit point. An ozone injector injects ozone created by an ozone generator into water flowing into a tank. The ozone concentration in the tank is monitored by a first sensor. Once the water in the tank has at least the threshold concentration of ozone, the water may be pumped to an exit point. A second sensor in proximity to the exit point monitors the ozone concentration of the treated water in proximity to the exit point. If the water in proximity to the exit point has at least the threshold concentration of ozone, the system allows a portion of the treated water to exit the system and be delivered to a point of use. The second sensor in proximity to the exit point assures the treated water that is actually delivered to the exit point has at least the threshold value of ozone concentration. This is accomplished by a loop system that allows treated water from the tank to be circulated in the loop even when no water is exiting the system.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is an example of an ozone water treatment system that assures the ozone concentration of water delivered to an exit point to be at least a threshold value as described and claimed herein;

FIG. 2 shows one suitable implementation of point of use area 170 in FIG. 1;

FIG. 3 shows a second suitable implementation of point of use area 170 in FIG. 1;

FIG. 4 shows one suitable implementation of a tank and additional features;

FIG. 5 shows one suitable implementation of a source of water for the ozone water treatment system;

FIG. 6 shows an exit point indicator;

FIG. 7 shows an exit point indicator and a point of use indicator;

FIG. 8 shows a system for determining when a filter needs to be replaced;

FIG. 9 shows a water quality monitor;

FIG. 10 shows an ozone gas destruction system;

FIG. 11 shows a second tank at an exit point;

FIG. 12 shows a second implementation of an ozone water treatment system that includes additional optional features not shown in FIG. 1;

FIG. 13 is a method for distributing ozone treated water and assuring the ozone concentration at an exit point to be at least a threshold value;

FIG. 14 is one suitable implementation of step 1330 in FIG. 13;

FIG. 15 is another suitable implementation of step 1330 in FIG. 13;

FIG. 16 is a method for determining if a water filter in the system needs to be replaced;

FIG. 17 is a method for eliminating excess ozone gas buildup in the air above the level of the water in the tank;

FIG. 18 is a method for providing an indication of whether or not the water at the exit point has at least a threshold ozone concentration;

FIG. 19 is a method for providing an indication of whether or not the water delivered to the point of use has at least a threshold ozone concentration;

FIG. 20 is a method for filling the tank;

FIG. 21 is a method for cooling the water in the tank;

FIG. 22 is a method for adjusting pH levels of the water in the tank;

FIG. 23 is a method for increasing the ozone generation;

FIG. 24 is a method for assuring the water delivered to an exit point from a holding tank has an ozone concentration that has dropped below a predetermined threshold;

FIG. 25 is a method for sending reports regarding the operation of the ozone water treatment system;

FIG. 26 is a method for autonomically adjusting the specifications of the ozone water treatment system;

FIG. 27 is a sample set of default specifications;

FIG. 28 is a sample set of run-time measurements;

FIG. 29 is a sample set of adjusted specifications;

FIG. 30 is a sample set of modular components to build the ozone water treatment system;

FIG. 31 is a sample set of additional modular components for the ozone water treatment system;

FIG. 32 is a method for building an ozone water treatment system from modular components according to customer requirements;

FIG. 33 is a method for building an ozone water treatment system from modular components according to customer requirements and water quality at the customer's operating site;

FIG. 34 is one suitable implementation for step 3310 in FIG. 33; and

FIG. 35 is another suitable implementation for step 3310 in FIG. 33.

### DETAILED DESCRIPTION

Water treated with ozone has a variety of uses. In a high enough concentration, water treated with ozone can be used to disinfect or sterilize surfaces that the treated water comes into contact with. Because of the high concentrations required and the short half-life of ozone in water, the ozone treated water must be produced close to where the location where the treated water will be used. Given the quick decomposition time of ozone in water, it is possible that the ozone concentration in water, while high enough in the tank, will have decayed to a concentration below that required for disinfecting or sterilizing by the time it travels to an exit point of the system, especially if the water sits for some time in a pipe between the tank and the exit point. A reduction in the ozone concentration can also happen during the time it takes for the treated water to travel through plumbing to get to the exit point. This is an undesirable result that could result in the ozone concentration in the treated water being below a desired threshold. The ozone water treatment system in the disclosure and claims solves this problem by assuring the ozone concentration in the treated water as actually delivered to the exit point remains at a minimum level defined by the specified threshold concentration of ozone.

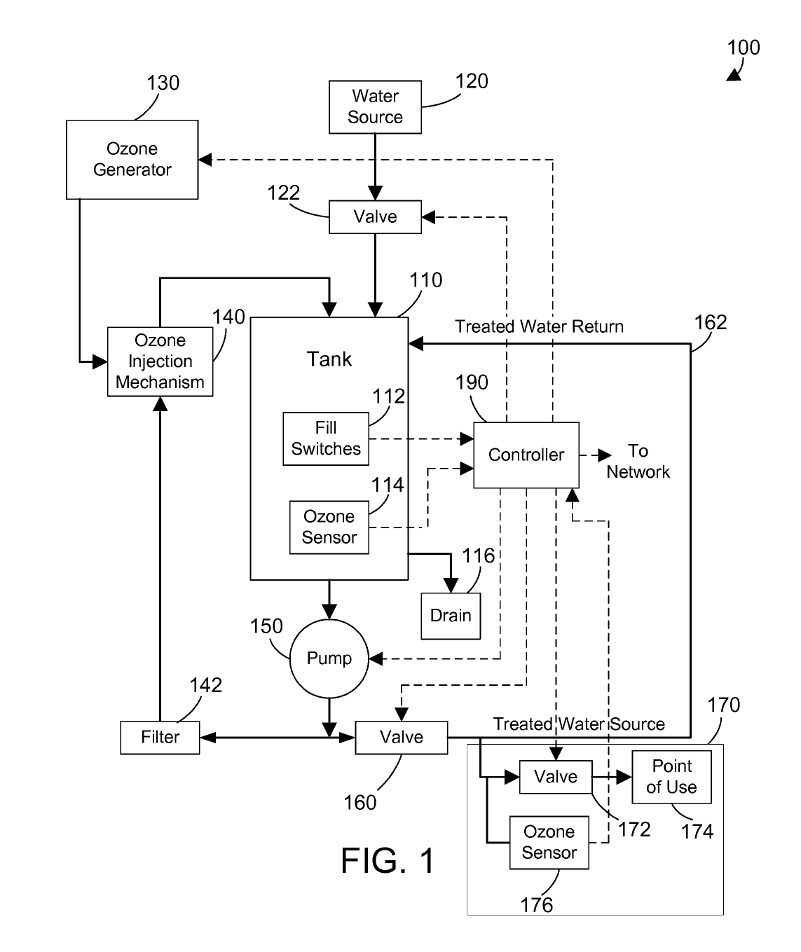

Described herein is a system for assuring that water treated with ozone has a threshold level of ozone concentration when delivered to an exit point. FIG. 1 discloses such a system. FIG. 1 shows a system 100 with a tank 110 with fill switches 112, ozone sensor 114, and a drain 116. A water source 120 is coupled to a valve 122 that is coupled to a water inlet port on tank 110. Ozone generator 130 is coupled to an ozone injection mechanism 140 that is coupled to tank 110. Pump 150 pumps water from tank 110 through valve 160, through treated water pipe 162 to a point of use area 170. Pump 150 also pumps water from tank 110 through filter 142, through the ozone injection mechanism 140 back into the tank. This provides a water cycling feature that allows increasing ozone concentration in the water in the tank. Point of use area 170 includes a valve 172 that represents an exit point, a point of use 174, and an ozone sensor 176 in proximity to valve 172. Controller 190 receives input from fill switches 112, ozone sensor 114, and ozone sensor 176 and can provide output to valve 122, ozone generator 130, pump 150, valve 160, valve 172, and an external network.

Tank 110 is a tank capable of holding water that has high levels of ozone concentration, such as any suitable plastic tank. One suitable tank is part number B118 manufactured by Ronco Plastics and distributed by Plastic Mart. Tank 110 receives water from water source 120. Fill switches 112 are monitored by controller 190. When fill switches 112 determine that water needs to be added to tank 110, controller 190 sends a signal to open valve 122. When fill switches 112 determine the level of water in tank 110 is at a desired level, controller 190 sends a signal to close valve 122. Fill switches 112 are configured so the amount of water in tank 110 is suitable for the desired ozone concentration given the demand of treated water supplied by the system. While fill switches 112 have been discussed and disclosed herein, the disclosure and claims extend to any means to keep tank 110 at an appropriate water level including any electrical, mechanical, or visual means whether currently known or developed in the future. For example, fill switches 112 could be a mechanical float valve, such as the ballcock valves commonly used in toilet tanks.

Ozone sensor 114 measures the ozone concentration of the water in tank 110 and provides an input to controller 190. Ozone concentration in water may be measured in any suitable way, whether currently known or developed in the future. Three known scales for measuring ozone concentration in water include: Oxidation-Reduction Potential (ORP), parts per million (ppm), and milligrams per liter (mg/L). ORP is a measure of the tendency of a solution to gain or lose electrons when subjected to change by introducing a new species. ORP is measured in millivolts (mV). A solution with a higher reduction potential than a new species the solution comes into contact with will gain electrons from the new species, thus oxidizing the new species. Oxidizing bacteria, viruses, and other unwanted organisms kills them. Water treated with ozone with an ORP level of 600 mV is considered a disinfectant meaning water treated with ozone with an ORP level of 600 mV has a higher reduction potential than most bacteria and will thus oxidize (destroy) most bacteria. Water treated with ozone with an ORP level of 800 mV is considered a sterilant meaning water treated with ozone with an ORP level of 800 mV has a higher reduction potential than all bacteria, viruses, or other organisms and will oxidize (destroy) all unwanted pathogens leaving the surface the treated water contacts completely sterile.

Ozone concentration measured in parts per million or mg/L are interchangeable if the solution is water. An ozone concentration that corresponds with the same ORP levels depends on the water's pH level. With a pH of about 7.5, ozone concentration is high enough to be a sterilant between 0.1 and 0.2 mg/L (ppm). [Note that any suitable threshold for ozone concentration could be used. Thus, if ORP sensors are used, and if a minimum of 800 mV is desired at each exit point, the ozone threshold in the tank could be set to 1000 mV, and the ozone threshold at each point of use could be set to 900 mV, just to provide some margin to assure the water exiting the system is a sterilant. In addition, much higher concentration of ozone could be used. Thus, while an ORP of 800 mV makes water a sterilant, a threshold ORP of 2,000 mV would provide more than enough ozone in the treated water with lots to spare. In addition, different thresholds for ozone concentration could be specified for different exit points in the system. The disclosure and claims herein expressly extend to any suitable number and value for thresholds of ozone concentration in the ozone water treatment system.

There are many ways to measure ozone concentration levels in water, including ORP sensors, electrochemical cells, ultraviolet light absorption, a Hach colorimeter, and stripping monitors that strip the dissolved ozone out of a solution and measure the concentration of dissolved ozone. One suitable example for ozone sensor 114 is an Oxidation-Reduction Potential (ORP) sensor that detects the Oxidation-Reduction Potential of a liquid. One suitable ORP sensor is part number HI 504 with HI2004-5 probe manufactured by Hanna Instruments. The ORP value is measured in millivolts (mV). The disclosure and claims herein extend to any way to measure ozone concentration in a liquid whether currently known or developed in the future. While FIG. 1 shows ozone sensor 114 physically inside tank 110, the disclosure and claims herein extend to any location or configuration of ozone sensor 114 to measure the ORP level of the water in tank 110. For example, ozone sensor 114 could be located in the pipe between the tank 110 and pump 150.

Ozone generator 130 generates ozone from the ambient air. There are many known methods and machines for generating ozone. The disclosure and claims herein extend to any method for making ozone whether currently known or developed in the future. One suitable ozone generator is the Ensure HECS30 manufactured by Guardian Manufacturing. Ozone generator 130 can be a variable-output ozone generator or a fixed-output ozone generator. One suitable implementation is to have a variable-output ozone generator 130 receive a signal from controller 190 to generate more or less ozone. Ozone injection mechanism 140 takes the ozone generated by ozone generator 130 and injects the ozone into water flowing into the tank 110. One suitable implementation for injecting ozone into water is a venturi. A venturi is comprised of a T shaped pipe where the water passes through the straight part of the T, the ozone gas is present at the branch part of the T, and the pressure difference from the water moving through the straight part of the T pulls the ozone gas into the water. The venturi is one simple implementation for ozone injection mechanism 140. The disclosure and claims herein extend to any mechanism or method for injecting ozone into a liquid whether currently known or developed in the future.

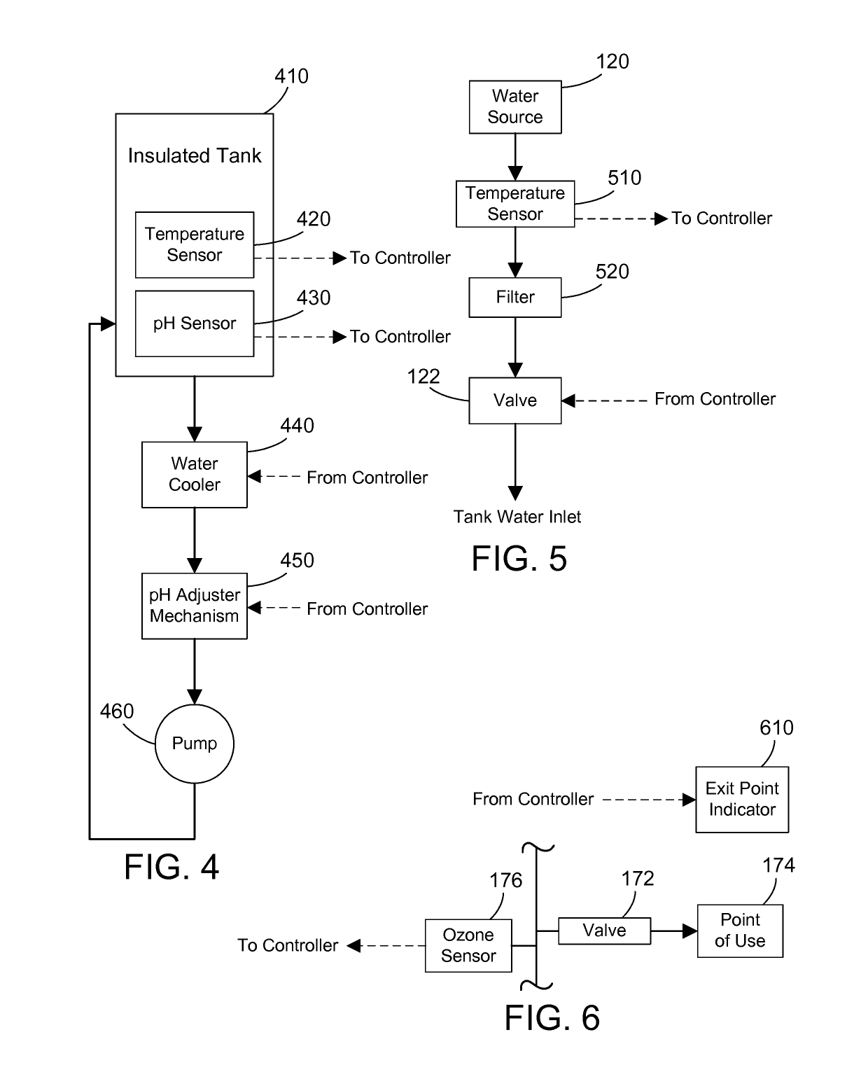

Pump 150 provides sufficient pressure to circulate water from tank 110, through treated water pipe 162, to valve 172, and to use the treated water at point of use 174. Pump 150 can be a variable pressure pump or a single pressure pump. Pump 150 can be the pump that circulates the water through the ozone injection mechanism, or there may be a separate pump that pumps the water through the ozone injection mechanism 140. Additionally, pump 150 can be the pump that circulates the water through a cooler, or the cooler may have a separate pump, as discussed below with reference to FIG. 4. In one suitable implementation pump 150 can be programmable and receive inputs from controller 190 to adjust the output pressure of pump 150. In another suitable implementation pump 150 is a single pressure pump. Under either implementation pump 150 provides sufficient pressure to circulate the water through treated water pipe 162 and to dispense some of the water at an exit point (such as valve 172) to a point of use 174.

The treated water pipe 162 includes a first end coupled to a treated water source port on the tank 110, and a second end coupled to the treated water return port on the tank 110. The pump 150 is provided inline in the treated water pipe 162 to pump water from the tank and provide pressure in the treated water pipe 162. Because the treated water pipe 162 allows circulation of water from and back to the tank when the pump 150 is on, the ozone concentration level in the water pipe may be changed simply by turning on the pump 150, even when no water is exiting the system. This causes the treated water to circulate from the tank 110, through the pump 150, through the treated water pipe 162, and back to the tank 110. This loop system allows water in the treated water pipe 162 to be refreshed with water from the tank should the ozone concentration at any exit point be too low.

Area of use 170 contains a valve 172, a point of use 174, and an ozone sensor 176. Ozone sensor 176 is positioned in proximity to valve 172, which is an exit point where treated water exits the system. For the disclosure and claims herein “proximity” means the ozone sensor 176 is closer to valve 172 than to tank 110 (i.e. ozone sensor 176 is less than 50% of the distance between valve 172 and tank 110 from valve 172). In a preferred implementation, ozone sensor 176 is less than 25% of the distance between valve 172 and tank 110 from valve 172. In a more preferred implementation, ozone sensor 176 is less than 10% of the distance between valve 172 and tank 110 from valve 172. The most preferred implementation is ozone sensor 176 is at the input of valve 172. Valve 172 is an exit point of system 100, meaning that valve 172 is where a portion of the water exits the apparatus. Valve 172 opens to allow a portion of the treated water to exit the apparatus only when ozone sensor 176 indicates the ozone concentration in the water is at or above a defined threshold value. If ozone sensor 176 indicates the water does not have the threshold value of ozone concentration, then valve 172 will not be opened. In one implementation valve 172 receives a signal from controller 190 indicating when valve 172 should open. Controller 190 sends that signal only when ozone sensor 176 indicates the water in proximity to valve 172 has at least the threshold ozone concentration. Point of use 174 is where the water is actually used. Note in some applications, the point of use may be some distance from the exit point of the system. For example, a hose bib could represent the valve 172, and a hose connected to the hose bib could convey the treated water to a point of use where the water exits the hose. Such a situation could exist, for example, in a deli area where the hose is used to spray down the floor and equipment for cleaning. In this example, the hose bib would represent the valve 172 in FIG. 1 that is an exit point for the system, while the point of use 174 would be the opposite end of the hose where water comes out. One of the benefits of system 100 is the ability to guarantee that water at each exit point has at least the threshold value of ozone concentration. To be able to make such a guarantee in the scenario with the deli hose above, the valve 172 would be a solenoid valve coupled to controller 190, and the hose bib would then be coupled to the output of the solenoid valve 172. In this manner the controller can shut off the solenoid valve 172 when the treated water does not have the threshold ozone concentration at the exit point as measured by the ozone sensor 176, thereby guaranteeing that any water that exits the system 100 has at least the threshold value of ozone concentration.

Controller 190 is a programmable logic controller that controls system 190. Controller 190 is programmed with ozone concentration thresholds that must be met before valves 160 or 172 can be opened. Controller 190 can receive inputs from fill switches 112, ozone sensors, and an external network. One suitable controller that could be used is controller DO-06DR sold by Automation Direct. Another suitable controller is controller CJ1M manufactured by Omron, with applicable input/output (I/O) modules. Note the term “controller” as used herein is not limited to programmable logic controllers, but expressly extends to any device or system capable of performing the functions of the controller recited herein, whether currently known or developed in the future.

While the ozone generator 130 is shown to be controlled by the controller 190 in FIG. 1, this is only needed when the ozone generator 130 is a variable-output ozone generator. When a fixed-output ozone generator is used for ozone generator 130, no control from the controller 190 is needed. Filter 142 is present to filter out oxidized contaminants from the water, thereby assuring the water is not only treated with ozone, but filtered as well. Drain 116 is provided to allow easily servicing the system 100 should the tank 110 need to be drained. Valve 122 could be a solenoid valve controlled by the controller 190, or could be a manual valve. Valves 160 and 172 could also be manual valves, but in the preferred implementation valves 160 and 172 are valves controlled by controller 190 so the system 100 can guarantee the water exiting the system has at least the threshold ozone concentration level.

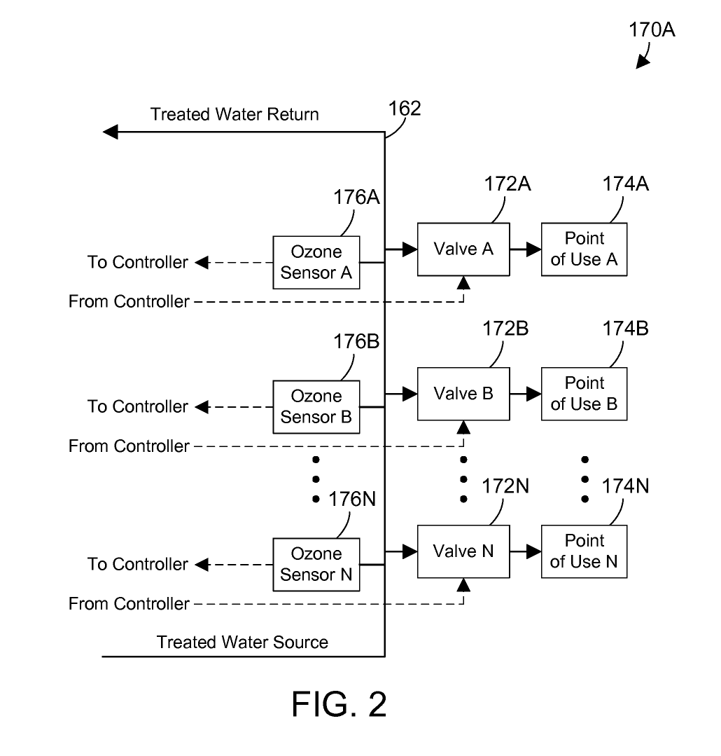

Referring to FIG. 2 point of use area 170A shows one suitable implementation for point of use area 170 in FIG. 1. Each of the valves 172A, 172B, . . . 172N is an exit point for system 100. An exit point is where water exits system 100. Each of the valves 172A, 172B, . . . 172N receives a signal from controller 190, and each has a corresponding ozone sensor shown as ozone sensors 176A, 176B, . . . 176N. Each of the ozone sensors 176A, 176B, . . . 176N provides an input to controller 190. Controller 190 only opens valve 172A to provide treated water at point of use 174A when the ozone sensor 176A in proximity to valve 172A senses water with at least a threshold ozone concentration. Similarly, controller 190 only opens valve 172B to provide treated water at point of use 174B when the ozone sensor 176B in proximity to valve 172B senses water with at least a threshold ozone concentration. Likewise, controller 190 only opens valve 172N to provide treated water at point of use 174N when the ozone sensor 176N in proximity to valve 172N senses water with at least a threshold ozone concentration. In this manner, the ozone generation system can guarantee that all treated water exiting the system has at least a specified minimum ozone concentration at each exit point.

Note that FIG. 2 shows ozone sensors and valves both in close proximity to the treated water pipe 162, which circulates treated water from and to the tank. However, in some situations, the valve (exit point) may be at a location that is not close to the treated water pipe 162. In this case, each exit point could have a loop that runs from the treated water pipe 162 back to the tank 110. By providing a separate loop for each exit point and sensor, the system 100 can guarantee the ozone concentration level at each point of use is at least on the required threshold before dispensing the treated water at the point of use.

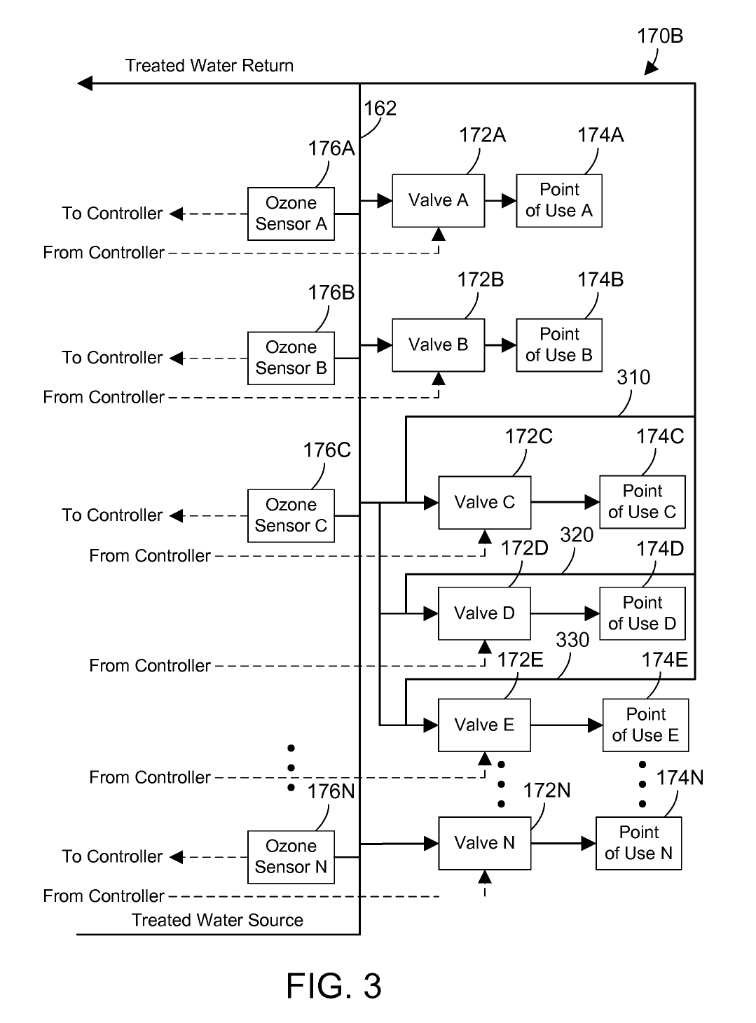

Referring to FIG. 3, point of use area 170B shows another suitable implementation for point of use area 170 in FIG. 1. Each of the valves 172A, 172B, 172C, 172D, 172E, . . . 172N is an exit point for system 100. An exit point is where water exits system 100. Each of the valves 172A, 172B, 172C, 172D, 172E, . . . 172N receives a signal from controller 190. Each of the ozone sensors 176A, 176B, 176C, . . . 176N is in proximity to their corresponding valves (exit points), and each provides an input to controller 190. Controller 190 only opens valve 172A to provide treated water at point of use 174A when the ozone sensor 176A in proximity to valve 172A senses water with at least a threshold ozone concentration. Controller 190 only opens valve 172B to provide treated water at point of use 174B when the ozone sensor 176B in proximity to valve 172B senses water with at least a threshold ozone concentration. Controller 190 only opens valve 172C to provide treated water at point of use 174C when the ozone sensor 176C in proximity to valve 172C senses water with at least a threshold ozone concentration. Controller 190 only opens valve 172D to provide treated water at point of use 174D when the ozone sensor 176C in proximity to valve 172D senses water with at least a threshold ozone concentration. Controller 190 only opens valve 172E to provide treated water at point of use 174E when the ozone sensor 176C in proximity to valve 172E senses water with at least a threshold ozone concentration. Controller 190 only opens valve 172N to provide treated water at point of use 174N when the ozone sensor 176N in proximity to valve 172N senses water with at least a threshold ozone concentration. Note as shown in this implementation it is possible for exit points to be in proximity to a single ozone sensor. Also note the three valves 172C, 172D and 172E are shown with their own return lines 310, 320 and 330, thereby providing independent loops through which the treated water can pass in proximity to each point of use.

The configuration in FIG. 3 could be representative of a treated water system 100 installed in a grocery store. We assume the grocery store includes a drinking water dispensing machine that fills gallon jugs at Point of Use A 174A. We further assume the grocery store includes an ice machine at Point of Use B 174B. Next we assume the produce area of the grocery store includes a misting system for the fresh vegetables. The misting system includes a plurality of misting heads, where each misting head is a point of use such as 174C, 174D and 174E, and corresponding solenoid valves 172C, 172D and 172E are exit points for the system, and an ozone sensor 176C measures the ozone concentration in proximity to the misting heads, where the controller only allows dispensing treated water at the misting heads by valves 172C, 172D and 172E when the ozone concentration detected by ozone sensor 176C is above a predetermined threshold. We further assume the treated water system includes a hose bib as a point of use 174N, where a hose and sprayer may be connected to clean the deli area of the grocery store. The valve 172N is an exit point of the system, and the hose bib, hose and sprayer interconnect the valve 172N and the point of use 174N. While the example in FIG. 3 shows a single ozone sensor 176C in proximity to valves 172C, 172D and 172E, it is equally within the scope of the disclosure and claims herein to include one ozone sensor per valve. If each valve has a corresponding ozone sensor, the misting system would appear as shown in FIG. 2.

While the above examples have been discussed with the valves being electronically activated, or able to be activated by controller 190, the disclosure and claims herein extend to any valve whether electronic, mechanical, or manual. Thus it is within the scope of the disclosure and claims herein for a manual faucet to be a valve that can be turned on by a person. There could be a mechanical lock that engages whenever the ozone concentration is not high enough. Alternatively there could be an indicator that shows when the concentration is high enough before the user would turn the faucet on. Of course, the preferred implementation is electrically-activated valves to the system can guarantee the ozone concentration at each point of use exceeds the required threshold before dispensing the treated water at each point of use.

Temperature is the enemy of ozone. Ozone in water at a cooler temperature has a much longer half life than in warmer water. Thus, to maintain the ozone concentration in the treated water at higher levels (i.e., to provide a longer half-life of the ozone in the treated water), the water may be cooled. In addition, the concentration of ozone in the water is affected by the water's pH level. Thus it may be necessary to adjust the pH level of incoming water to change the pH to an optimal range. Referring to FIG. 4, tank 410 is a thermally insulated tank. One suitable insulated tank is part number B118 Insulated manufactured by Ronco Plastics and distributed by Plastic Mart. Insulated tank 410 has a temperature sensor 420 and a pH sensor 430. While FIG. 4 shows temperature sensor 420 and pH sensor 430 physically inside tank 410, the disclosure and claims herein extend to any location of temperature sensor 420 and pH sensor 430 to measure the temperature and pH level, respectively, of the water in tank 410. One suitable temperature sensor is part number PH500 with a HI1006-2205 probe manufactured by Hanna Instruments. One suitable pH sensor is PH500 with a HI1006-2205 probe manufactured by Hanna Instruments. Tank 410 is coupled to water cooler 440, pH adjuster mechanism 450, and pump 460. Water cooler 440 is an inline cooler that cools water as it passes through. Water cooler 440 could be a relatively small water cooler, such as those found in drinking fountains. One suitable water cooler is part number BP015 manufactured by Bosch Group. While an inline cooler is shown in FIG. 4, cooling coils on the tank 410 could also or alternatively be used to cool the treated water in the tank 410. pH adjuster mechanism 450 adds one substance to increase the pH level of the water and a second substance to decrease the pH level of the water. [One suitable pH adjuster is part number pHASE pH05 manufactured by Digital Analysis Corp or a custom unit provided by Panner Sales Company. One suitable substance that could be added to increase the pH level of the water is sodium hydroxide. One suitable substance that could be added to decrease the pH level of the water is acetic acid. Pump 460 cycles water from tank 410 through water cooler 440 and pH adjuster mechanism 450 and back to tank 410. While pump 460 is shown as a separate pump in FIG. 4, pump 460 could be within water cooler 440, or the function of pump 460 could be performed by a different pump, for example, pump 150 in FIG. 1. Temperature sensor 420 and pH sensor 430 provide input to controller 190. Water cooler 440 and pH adjuster mechanism 450 receive signals from controller 190 to control their function.

Referring to FIG. 5, water source 120 is coupled to a temperature sensor 510, filter 520, and valve 122. Valve 122 is coupled to the water inlet port on tank 110. In one suitable implementation water source 120 is the local water supply at the site of use. In another implementation, water source 120 is a water source from a tank, bottle, or other contained source. Temperature sensor 510 monitors the temperature of the incoming water from water source 120, and provides an input to controller 190. Filter 520 filters the incoming water. Valve 122 receives a signal from controller 190 and is opened when water needs to be added to tank 110. By monitoring the temperature of the water coming from the water source using temperature sensor 510, the treated water system 100 can make adjustments according to the temperature of the water from the water source 120. For example, if the temperature of the water coming from the water source goes up, more ozone may be needed, while less may be needed when the temperature of the water coming from the water source goes down.

Referring to FIG. 6, exit point indicator 610 receives a signal from controller 190 to provide an indication of whether or not the water at the exit point is at or above the predetermined ozone concentration. Thus, controller 190 sends a signal to exit point indicator 610 to indicate whether the water at ozone sensor 176 in proximity to valve 172 has the threshold ozone concentration. Exit point indicator 610 can be a visual or audio indication, a message to a network, or a call or text message. The visual or audio indication is preferably in proximity to the exit point. One suitable example is a red and green LED at the exit point. A second suitable example is a red and green LED at the point of use 174, assuming the distance between the exit point 172 and the point of use 174 is not excessive. A red LED is illuminated when the ozone concentration detected by the ozone sensor 176 is below the required threshold and a green LED is illuminated when the ozone concentration detected by the ozone sensor 176 is above the required threshold. In this manner, a user has a visual indication of whether the water is at the desired ozone concentration at a particular exit point or point of use.

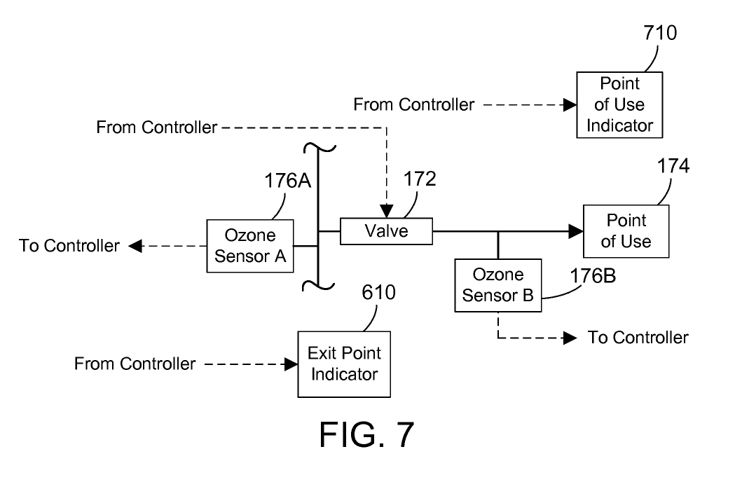

Referring to FIG. 7, a point of use indicator 710 receives a signal from controller 190. Controller 190 sends a signal to point of use indicator indicating whether the water at ozone sensor 176B in proximity to point of use 174 has the threshold ozone concentration. Point of use indicator 710 can be a visual or audio indication, a message to a network, or a call or text message. The visual or audio indication is preferably in proximity to point of use 174. Additionally exit point indicator 610 provides an indication valve 172 whether the water at ozone sensor 176A in proximity to valve 172 has the threshold ozone concentration. For example, one suitable use for the system would be to provide a water hose that can spray sterilizing water. If the water hose is not used for a certain time period, the ozone concentration of the water in the hose would not meet the threshold level of ozone concentration to be a sterilant. Thus there could be an exit point indicator, such as a red and green LED on the sprayer head on the end of the hose, that indicates whether the water at the sprayer head (point of use) has the required ozone concentration. If point of use 174 requested water and ozone sensor 176A determined that water in proximity to valve 172 had the threshold ozone concentration, exit point indicator 710 would show a green LED indicating the threshold concentration has been met. Controller 190 then sends a signal to open valve 172. Point of use indicator 710 shows a red LED indicating the threshold concentration detected by ozone sensor 176B is not yet at the threshold concentration at the point of use 174. Thus the LED on point of use indicator 710 will remain red until enough water has travelled through the hose and the water at ozone sensor 176B has the required ozone concentration, at which point the LED will turn green. Note this requires a special hose that includes wires to connect the point of use sensor 176B and point of use indicator 710 to controller 190. Such a hose and system provides a visual indication to the user to know when the water is at the desired ozone concentration. This dual indication, one at the exit point and one at the point of use, is very handy. A person using the hose and sprayer could note the green LED at the exit point and the red LED at the sprayer head, and could then direct water from the sprayer head into a drain until the LED on the sprayer head turns green, at which time the water can be used for the desired purpose because it is now at or above the predetermined threshold ozone concentration.

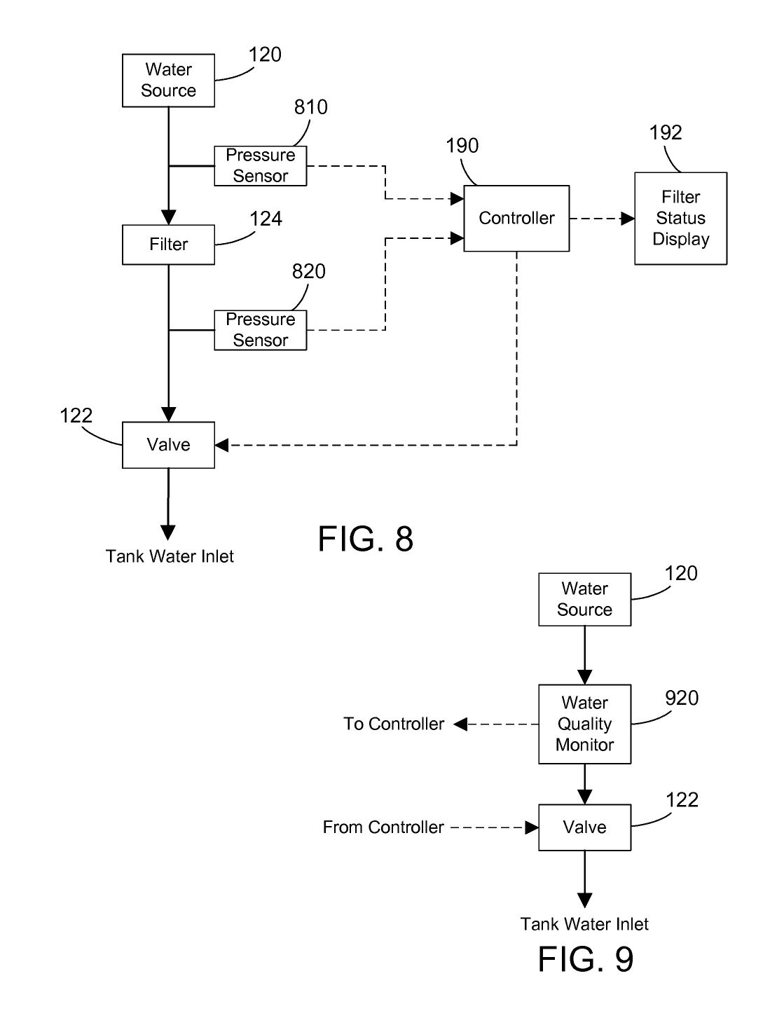

Referring to FIG. 8, water source 120 is coupled to filter 124 which is coupled to valve 122. Pressure sensor 810 monitors the pressure on the input of filter 124, while pressure sensor 820 monitors the pressure on the output of filter 124. Both pressure sensors 810 and 820 provide an input to controller 190. When the pressure measured by pressure sensor 820 is a specified difference from pressure measured by pressure sensor 810 (i.e., the pressure drop across the filter reaches some specified threshold), the filter needs to be serviced (e.g., replaced or backflushed). The controller 190 provides an output to filter status display 192. Filter status display 192 can provide a constant indication of the state of filter 124, or alternatively can provide an indication only when filter 124 needs to be serviced. Additionally, when filter 124 needs to be replaced controller 190 could provide an indication by a network message, a visual or audio indication, or a call or text to a phone of the system administrator. The filter status display 192 could also specify a remaining life of the filter according to the sensed pressure difference across filter 124.

Referring to FIG. 9, a water source 120 is coupled to water quality monitor 920 which is coupled to valve 122. Water quality monitor 920 monitors the incoming water quality of water source 120. Water quality monitor can monitor and report to controller 190 any of the water characteristics, including but not limited to temperature, pH, calcium content, iron content, chemical pollutant content, etc. Water quality monitor 920 can make any suitable measurement using any suitable technology, whether currently known or developed in the future. Because the temperature, pH, and presence of chemicals and minerals can affect the half-life of ozone in the treated water, monitoring the water quality allows adjusting the process to maintain the ozone concentration in the treated water at or above the specified threshold.

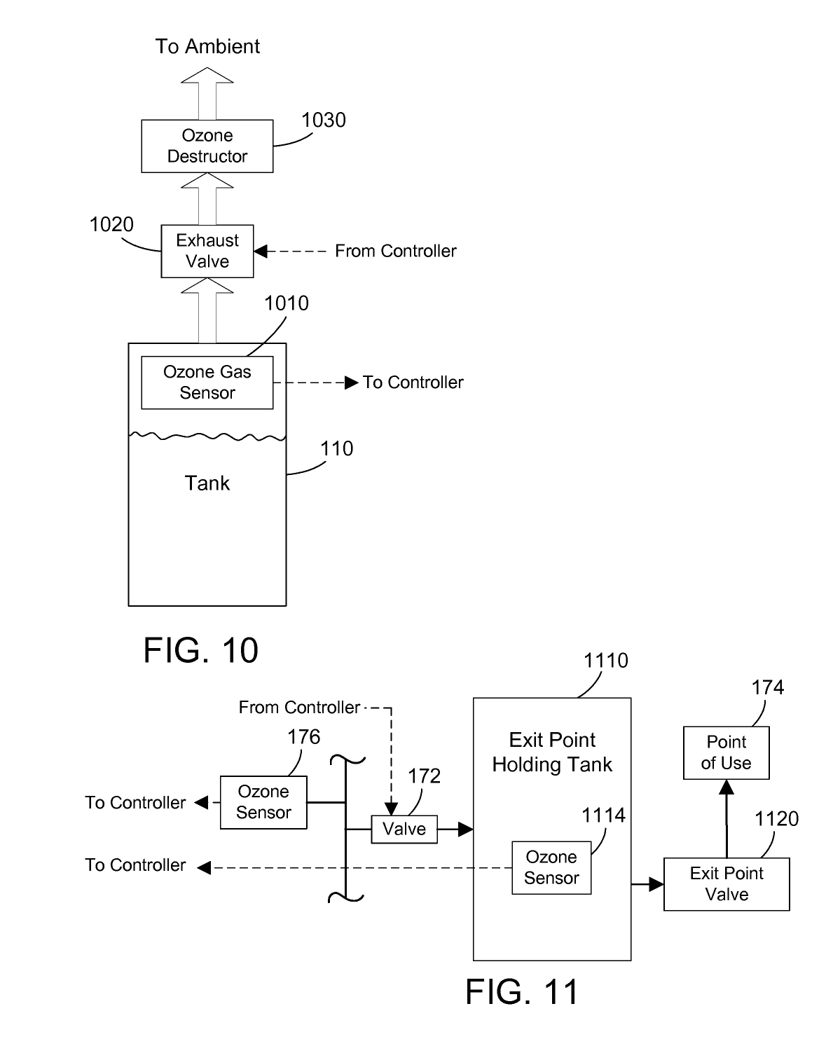

Referring to FIG. 10, tank 110 may optionally contain an ozone gas sensor 1010 that senses ozone concentration of the air in tank 110 that is above the level of the treated water in the tank. While FIG. 10 shows ozone gas sensor 1010 physically inside tank 110, the disclosure and claims herein extend to any location of ozone gas sensor 1010 to measure the concentration of ozone gas in the air in tank 110. Exhaust valve 1020 is coupled to tank 110. When ozone gas sensor 1010 detects the ozone gas in the air in tank 110 is above a specified threshold, controller 190 opens exhaust valve 1020 to allow the air from tank 110 to pass into ozone destructor 1030. Ozone destructor 1030 can simply be a heater that heats the air exiting the tank through the exhaust valve 1020 such that the ozone rapidly decomposes into oxygen. Once the ozone has been destroyed in ozone destructor 1030 the resulting oxygen and accompanying air is released into the ambient atmosphere. If the air flow from the tank through the exhaust valve 1020 to the ozone destructor 1030 is insufficient, a fan can be added to boost the speed of the air flow.

There may be a case where treating water with a relatively high concentration of ozone is desirable, but dispensing the water when it has the high concentration is not desirable. This could be the case, for example, when treated water is dispensed to a soft drink machine. If the ozone concentration in the water is too high, it is possible that an adverse taste may result. Thus, it may be desirable to allow the concentration of ozone to decay to a lower level before dispensing the treated water. Such a system requires a second tank as shown in FIG. 11. An exit point holding tank 1110 receives water from valve 172. Controller 190 does not open valve 172 unless the water has the threshold concentration as indicated by ozone sensor 176. Ozone concentration in the exit point holding tank 1110 is monitored by ozone sensor 1114. While FIG. 11 shows ozone sensor 1114 physically inside exit point holding tank 1110, the disclosure and claims herein extend to any location of ozone sensor 1114 to measure the concentration of ozone in the treated water in tank 1110. Water enters exit point holding tank 1110 at a first threshold of ozone concentration. The water is held in the exit point holding tank 1110 until the ozone concentration falls below a second threshold concentration as monitored by ozone sensor 1114. Once the concentration of ozone in the treated water in the point of use holding tank 1110 has dropped below the second threshold, the valve 1120 (exit point) may be opened and water is distributed to point of use 174. This type of holding tank at the point of use would be very useful in many applications, including fountain drink dispensers, drinking fountains, refrigerators, recreational vehicles (RVs), etc. When the treated water entering the point of use holding tank has a relatively high concentration of ozone, the inside of the point of use holding tank 1110 is sterile, free from all bacteria, viruses and contaminants, which avoids the bad taste that can result from pumping water from may known storage tanks, such as those on RVs. Similarly, a refrigerator could include a small-scale system 100 that would treat the water dispensed in the refrigerator door and used to make ice so the water is always fresh and clean, regardless of the quality of the incoming water supply.

The same configuration in FIG. 11 could be used in a system where different ozone concentration levels are needed at different points of use. For this specific example, the ozone concentration in the tank 110 will be set to the highest ozone concentration level needed by any point of use. An exit point holding tank 1110 as shown in FIG. 11 could then be placed in proximity to each exit point that requires an ozone concentration level that is lower than the ozone concentration in the tank. The treated water may then be held in the exit point holding tank 1110 until the ozone concentration level drops to some desired threshold, at which point the controller activates the exit point valve 1120 to dispense the treated water at the point of use 174.

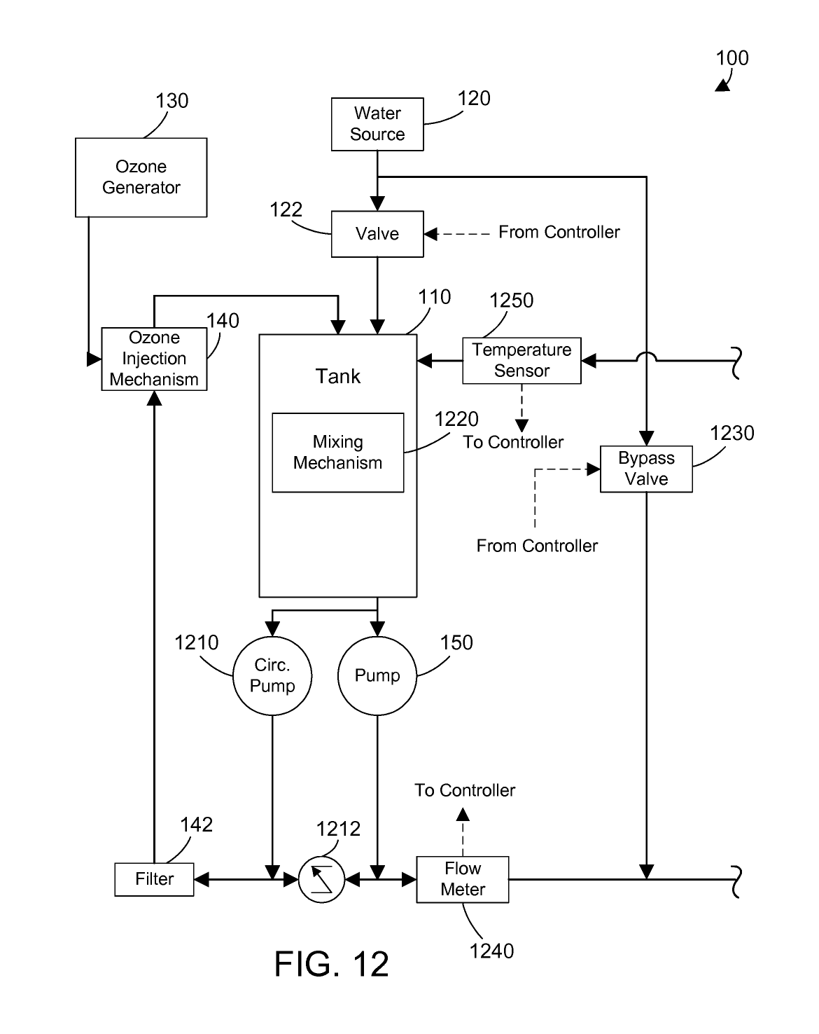

Referring to FIG. 12, system 100 can optionally include other features not shown in FIG. 1. For example, circulation pump 1210 could be included to circulate water from tank 110 through filter 142, through ozone injection mechanism 140, and back into tank 110. Note the circulation pump 1210 could also pump the water from the tank through a water cooler and back into the tank, as shown in FIG. 4. Circulation pump 1210 may be fixed speed or variable speed. Having a separate circulation pump 1210 can be useful when the power to run the circulating pump 1210 is considerably less than the power to run pump 150. In this situation, it would be inefficient to run the larger pump 150 just to inject ozone. Additionally, circulation pump 1210 could be part of an ozone generation system that includes ozone generator 130, ozone injection mechanism 140 and circulation pump 1210. In the alternative, circulation pump 1210 could be part of a water cooler 440 shown in FIG. 4. Note the check valve 1212 that prevents the circulation pump 1210 from pumping treated water into the treated water pipe while allowing the circulation pump to circulate water through filter 142 and ozone injection mechanism 140 into tank 110. This check valve 1212 allows the pump 150 to perform two functions simultaneously, namely deliver treated water to the points of use, and also to circulate the treated water through the filter 142 and the ozone injection mechanism 140 into tank 110. In the alternative, two check valves could be located on the outputs of circulation pump 1210 and pump 150. Tank 110 in FIG. 12 also includes a mixing mechanism 1220 which mixes the water inside tank 110 to keep the ozone concentration evenly distributed in the treated water in the tank. Mixing mechanism 1220 could be any suitable means to mix water in tank 110, including but not limited to, a pump, a mechanical agitator, air bubbles, etc. FIG. 12 also discloses a bypass valve 1230. The bypass valve 1230 is provided in the event there is a failure in the ozone water treatment system 100. Should the ozone water treatment system fail such that it cannot deliver treated water with the desired threshold concentration of ozone, the bypass valve 1230 could be turned on so water is directed from the water source 120 directly to the exit points of the system. For example, it would be better to have water direct from the water source to mist the fresh vegetables in the supermarket than to have no water available due to a failure in the system 100. The bypass valve 1230 could be a solenoid valve controlled by the controller, or could be a manual valve.

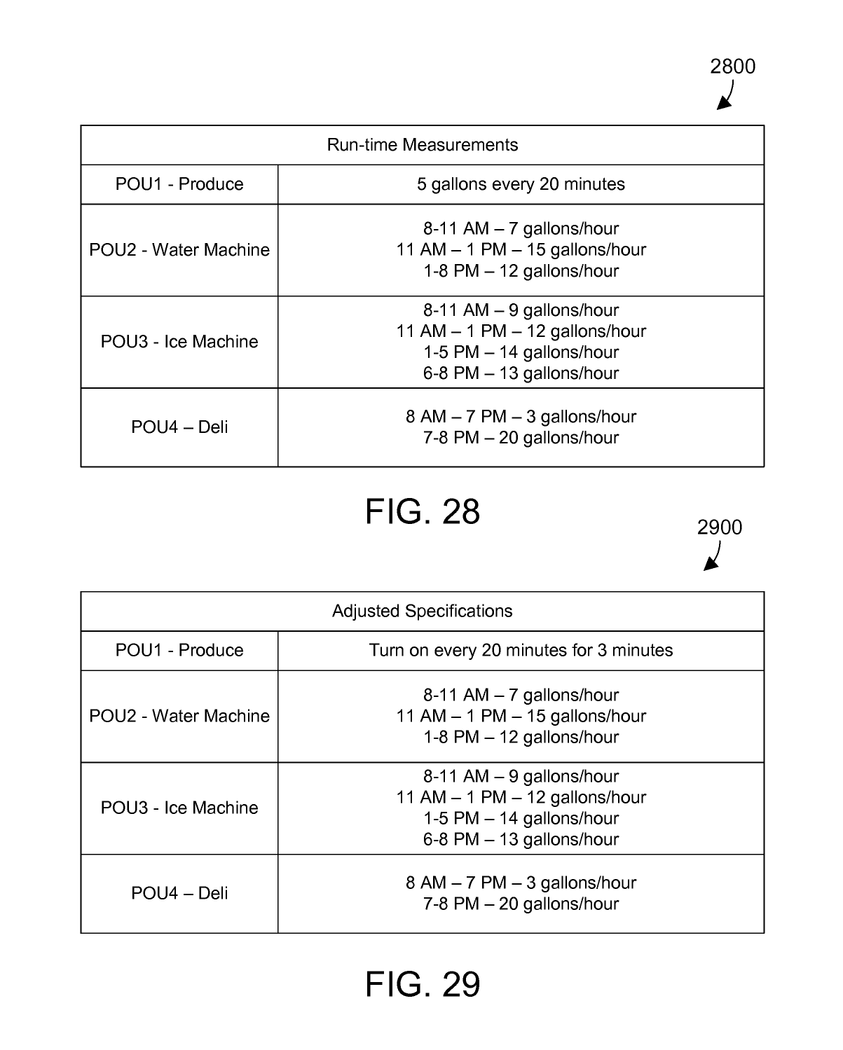

FIG. 12 additionally includes flow meter 1240 that monitors the flow of water to the exit points of the system. This information is relayed to controller 190. The flow meter 1240 is especially useful in making run-time measurements, discussed below with reference to FIG. 28. FIG. 12 also includes temperature sensor 1250 which monitors the temperature of water returning from the exit points. This information is relayed to controller 190. If the water temperature rises too much in the treated water pipe, an alert can be sent to the system administrator and the pipes can be insulated or the ambient temperature around the pipes reduced.

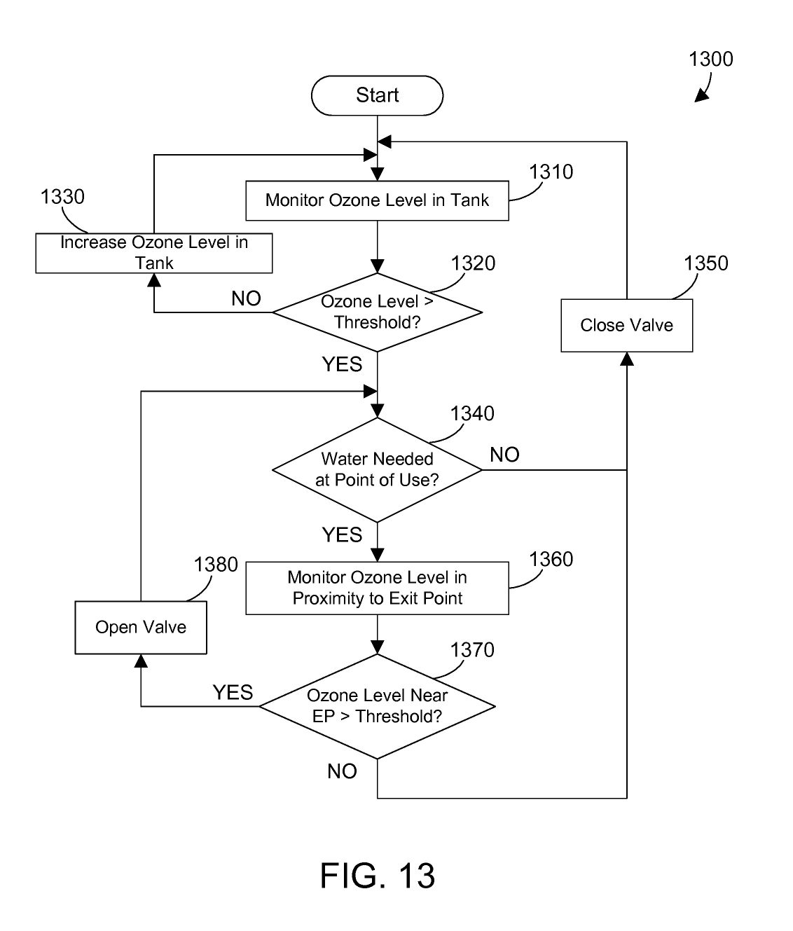

Referring to FIG. 13, a method 1300 for delivering water to a point of use begins by monitoring the ozone level in the tank (step 1310). For the discussion herein, monitoring ozone level means monitoring the concentration of ozone in the water. If the ozone level in the tank is not greater than the threshold (step 1320=NO), then the ozone level in the tank is increased (step 1330). If the ozone level in the tank is greater than the threshold (step 1320=YES), then method 1300 moves to step 1340. If water is not needed at the point of use (step 1340=NO), then the valve is closed (step 1350) and method 1300 returns to step 1310. If water is needed at the point of use (step 1340=YES), then the ozone level in proximity to the exit point is monitored (step 1360). If the ozone level in proximity to the exit point is greater than the threshold (step 1370=YES), then the valve is opened (step 1380), and method 1300 returns to step 1340. If the ozone level in proximity to the exit pint is not greater than the threshold (step 1370=NO), then the valve is closed (step 1350), and method 1300 returns to step 1310. Method 1300 assures the valve at an exit point of the system is only opened when the ozone concentration is above the predetermined threshold, thereby guaranteeing that system 100 only delivers water when its ozone concentration is above the required threshold.

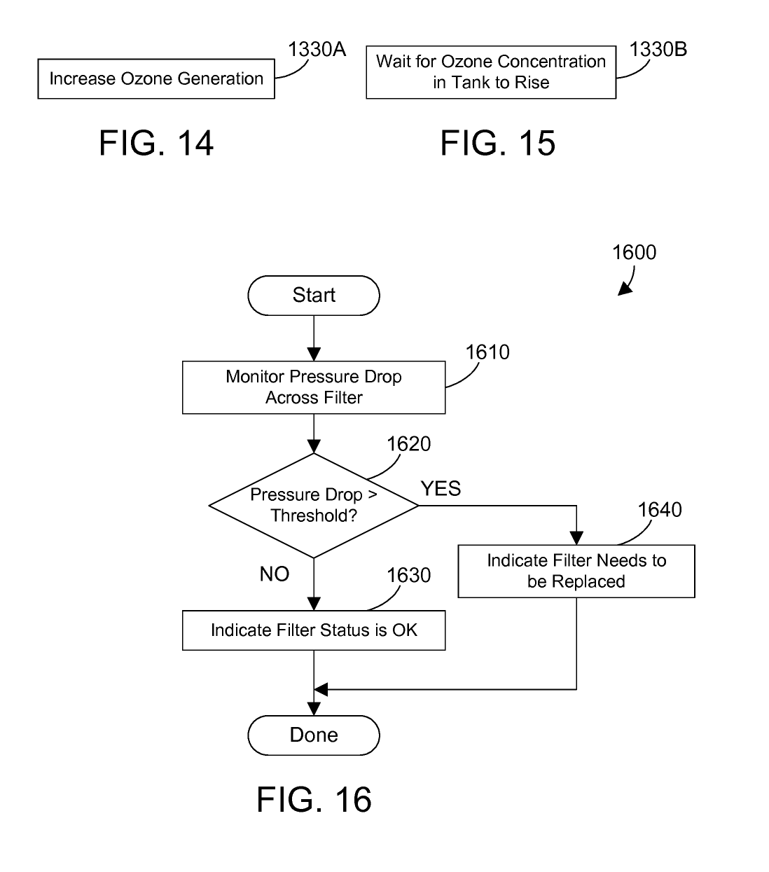

FIGS. 14 and 15 show alternative implementations for step 1330 in FIG. 13. FIG. 14 shows the step for increasing the ozone level in the tank by increasing ozone generation (step 1330A). This is possible when the ozone generator is a variable-output generator that is not working at its maximum output. FIG. 15 shows the step for increasing the ozone level in the tank by waiting for the ozone concentration in the tank to rise (step 1330B). Step 1330B is the preferred way to increase the ozone concentration in the tank when using a fixed-output ozone generator.

Referring to FIG. 16, a method 1600 for determining if a filter needs to be replaced begins with monitoring the pressure drop across a filter (step 1610). If the pressure drop is greater than a required threshold (step 1620=YES), then an indication is made that the filter needs to be replaced (step 1640) and method 1600 is done. If the pressure drop is not greater than the threshold (step 1620=NO), then an indication is made that the filter status is OK (i.e., does not need to be replaced) (step 1630), and method 1600 is done. Method 1600 is best understood with reference to FIG. 8. The pressure drop is determined by measuring the pressure at pressure sensors 810 and 820. This information is sent to controller 190 that drives filter status display 192. If the pressure difference between pressure sensors 810 and 820 is above a threshold defined in controller 190 (step 1620=YES in FIG. 16), then filter status display 192 shows filter 124 needs to be replaced (step 1640 in FIG. 16). If the pressure difference between pressure sensors 810 and 820 is below the threshold (step 1630=NO in FIG. 16), then filter status display 192 shows filter 124 does not need to be replaced (step 1630 in FIG. 16). As stated above in the discussion of FIG. 8, the filter status display can also include a “remaining life of filter” indication that is inversely proportional to the pressure drop across the filter.

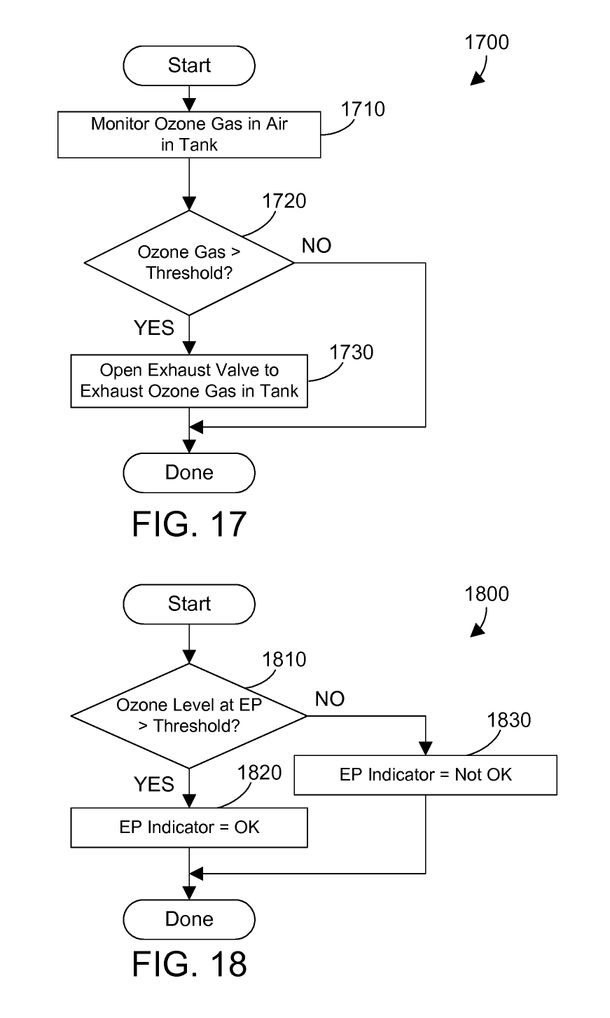

Referring to FIG. 17, a method 1700 for destroying ozone gas in tank 110 as shown in FIG. 10 begins by monitoring ozone gas in the air above the level of the treated water in the tank (step 1710). If the ozone gas in the air is above a defined threshold (step 1720=YES), then the exhaust valve is opened to exhaust the ozone gas from the air in the tank (step 1730) to an ozone destructor, and method 1700 is done. If the ozone gas is not above a defined threshold (step 1720=NO), then method 1700 is done.

Referring to FIG. 18, a method 1800 for indicating at an exit point whether the water at the exit point has a threshold ozone concentration begins at step 1810. If the ozone level in proximity to the exit point is greater than the threshold (step 1810=YES), then the exit point indicator indicates the ozone level of the water is above the threshold (step 1820), and method 1800 is done. If the ozone level in proximity to the exit point is not greater than the threshold (step 1810=NO), then the exit point indicator indicates the ozone level of the water is below the threshold (step 1830), and method 1800 is done.

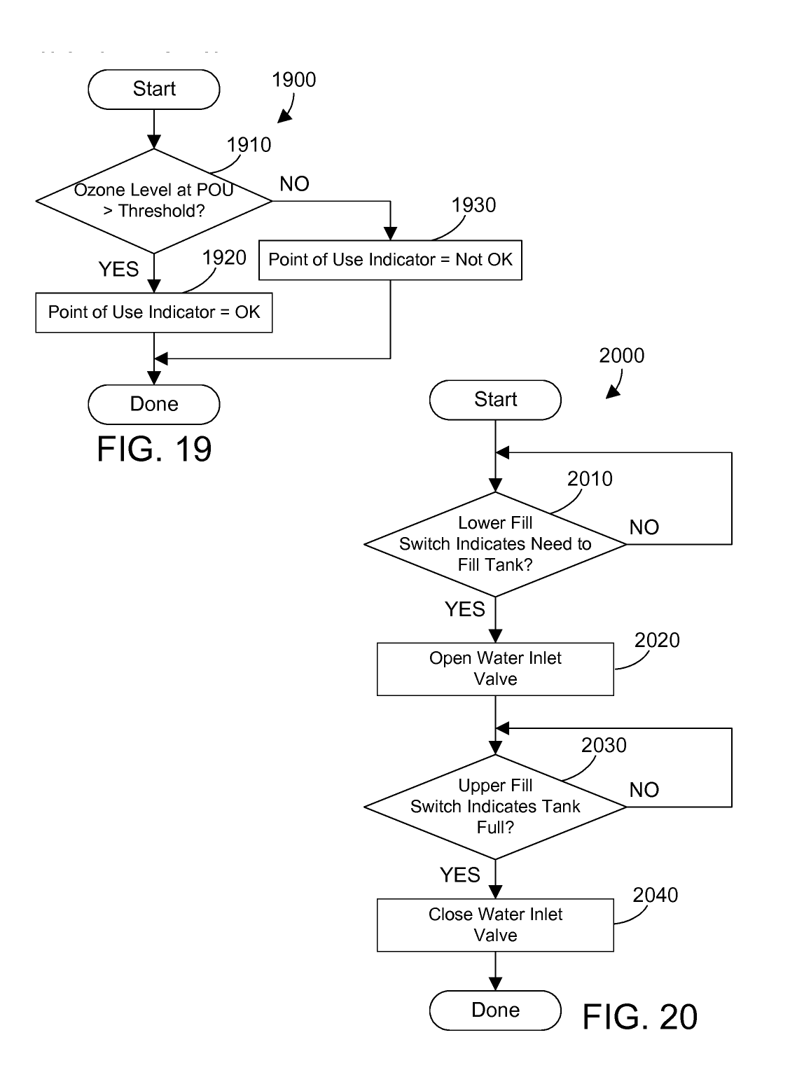

Referring to FIG. 19, a method 1900 for indicating at a point of use whether the water at the point of use has a threshold ozone concentration begins at step 1910. If the ozone level in proximity to the point of use is greater than the threshold (step 1910=YES), then the point of use indicator indicates the ozone level of the water is above the threshold (step 1920), and method 1900 is done. If the ozone level in proximity to the point of use is not greater than the threshold (step 1910=NO), then the point of use indicator indicates the ozone level of the water is below the threshold (step 1930), and method 1900 is done. Note that methods 1800 in FIGS. 18 and 1900 in FIG. 19 are both used when there is a point of use indicator separate from the exit point indicator, as shown in FIG. 7.

Referring to FIG. 20, a method 2000 for filling the tank begins with step 2010. If the lower fill switch in the tank does not indicate that the tank needs to be filled (step 2010=NO), then method 2000 returns to step 2010. If the lower fill switch in the tank indicates the tank needs to be filled (step 2010=YES), then the water inlet valve is opened (step 2020), and method 2000 goes to step 2030. If the upper fill switch in the tank does not indicate that the tank is full (step 2030=NO), then method 2000 returns to step 2030 and the tank continues filling. When the upper fill switch in the tank indicates the tank is full (step 2030=YES), then the water inlet valve is closed (step 2040), and method 2000 is done. For the purpose of method 2000 in FIG. 20, the tank is “full” when the upper fill switch indicates the tank is full, regardless of what percentage of the tank is physically filled with water when the upper fill switch makes the full indication.

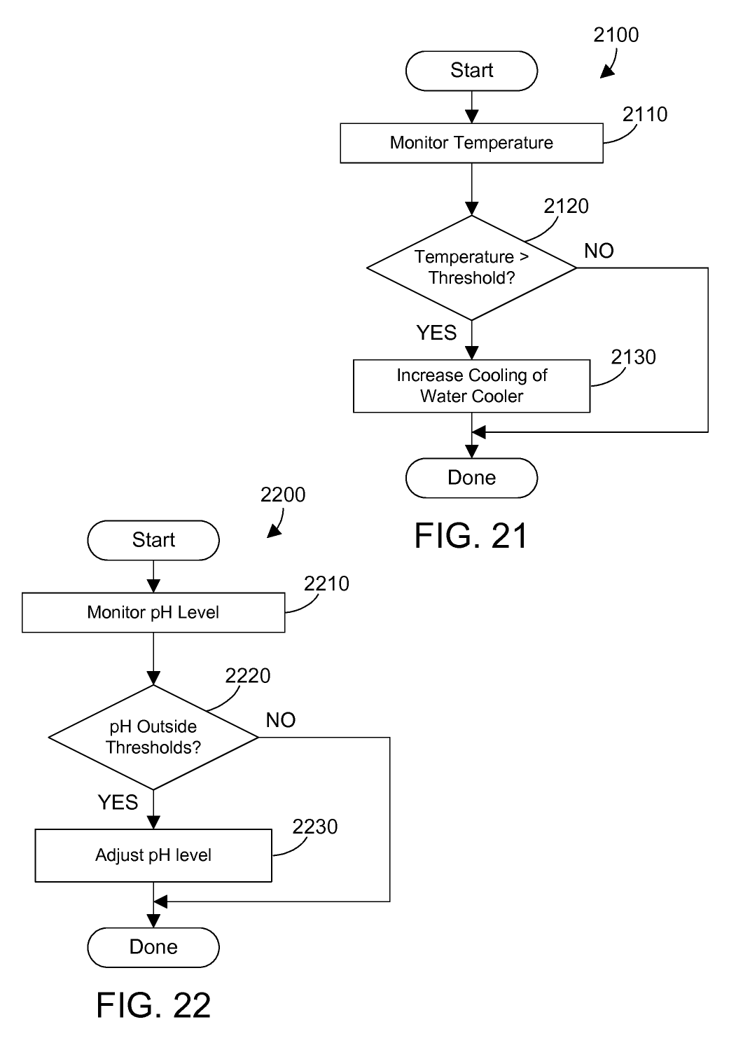

Referring to FIG. 21, a method 2100 for cooling the water in the tank begins by monitoring the temperature of the water (step 2110). If the temperature of the water is below a defined threshold (step 2120=NO) then method 2100 is done. If the temperature of the water is above a defined threshold (step 2120=YES), then the water cooling is increased (step 2130), and method 2100 is done. Method 2100 could be used with the system shown in FIG. 4. In the alternative, method 2100 could be used with a tank that includes cooling coils to cool the water in the tank.

Referring to FIG. 22, a method 2200 for adjusting the pH level of water in the tank begins by monitoring the pH of the water in the tank (step 2210). If the pH of the water is not outside defined pH thresholds (step 2220=NO), then method 2200 is done. If the pH of the water is outside the defined pH thresholds (step 2220=YES), then the pH level is adjusted (step 2230), and method 2200 is done. Method 2210 could be used with the system shown in FIG. 4. As discussed above, the pH of the treated water may be adjusted up or down by adding different additives, such as chemicals, to the treated water.

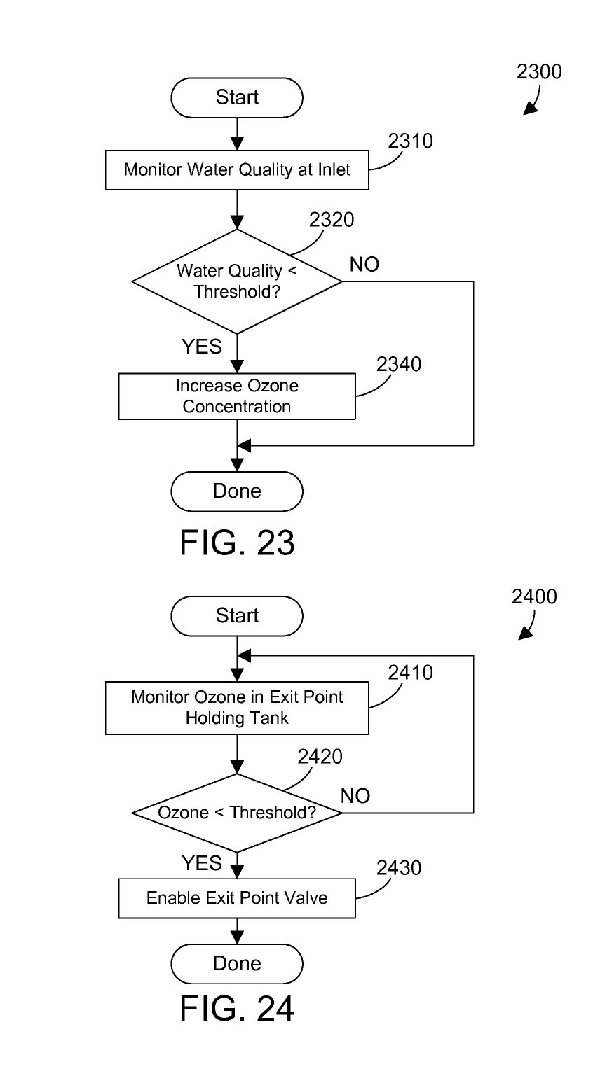

Referring to FIG. 23, a method 2300 for increasing ozone concentration when needed begins by monitoring the water quality at the inlet water source (step 2310). If the water quality is not less than a specified threshold (step 2320=NO), then method 2300 is done. If the water quality is less than the specified threshold (step 2320=YES), then the ozone concentration is increased (step 2340), and method 2300 is done. Method 2300 allows increasing ozone concentration to compensate for a reduction in water quality. Note that increasing the ozone concentration in step 2340 may be done using either method shown in FIG. 14 or 15.

Referring to FIG. 24, a method 2400 for allowing water treated with ozone to decay to a second threshold before being output to a point of use begins by monitoring the ozone concentration in water in an exit point holding tank (step 2410). When the ozone level is above the second threshold (step 2420=NO), then method 2400 returns to step 2410. When the ozone level drops below the second threshold (step 2420=YES), then the exit point valve is enabled (step 2430) and method 2400 is done. Enabling the point of use valve in step 2430 simply means the point of use valve may be turned on when needed because the ozone concentration in the exit point tank has dropped sufficiently. As discussed above, this may have application in RV tanks, drinking fountains, fountain drink dispensers, refrigerators, etc.

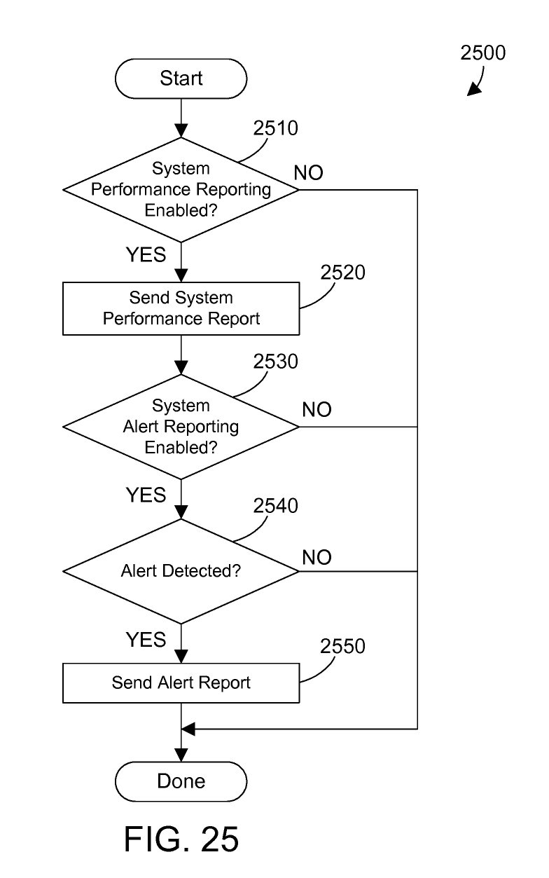

Referring to FIG. 25, a method 2500 for sending system reports begins with determining if system performance reporting has been enabled (step 2510). If system performance reporting has not been enabled (step 2510=NO), then method 2500 is done. If system performance reporting has been enabled (step 2510=YES), then a system performance report is sent (step 2520), and method 2500 moves to step 2530. If system alert reporting is not enabled (step 2530=NO), then method 2500 is done. If system alert reporting is enabled (step 2530=YES), then method 2500 moves to step 2540. If an alert has not been detected (step 2540=NO), then method 2500 is done. If an alert has been detected (step 2540=YES), then an alert report is sent (step 2550), and method 2500 is done. Method 2500 allow reporting performance and alerts to any suitable device, such as a computer network, cell phone, alarm, etc.

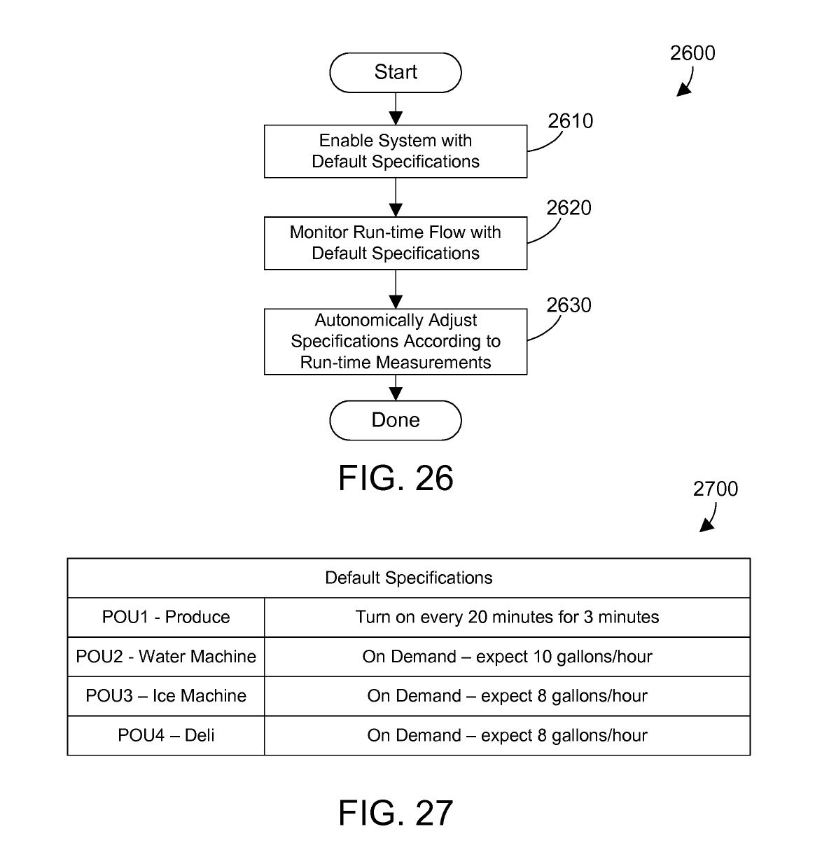

The functionality provided by the controller allows the controller to intelligently adjust its performance according to observed conditions. Referring to FIG. 26, a method 2600 for adjusting specifications in controller 190 begins by enabling the system with default specifications (step 2610). The system runs with the default specifications and the run-time flow is monitored (step 2620). The specifications are autonomically adjusted according to the run-time measurements (step 2630) and method 2600 is done.

A simple example is now provided to illustrate method 2600 in FIG. 26. FIG. 27 shows default specifications 2700 for the grocery store example discussed above that includes four points of use, one in the produce department, one at the water machine, one at the ice machine, and one in the deli. For the purpose of this discussion, all the different points of use (i.e., misting heads) in the produce area are grouped together as one point of use POU1. The default specifications 2700 are the best guess at what the system will need to provide at each of the four points of use.

The controller then begins operation, and logs the actual run-time measurements 2800 shown in FIG. 28. For this example, the misters in the produce area are turned on for three minutes every 20 minutes, which consumes 5 gallons during each three minute period they are turned on. The use of treated water at the water machine and ice machine varies according to time of day. The use of treated water at the deli also varies, with small amounts used each hour until the deli is cleaned from 7-8 PM, at which time the usage goes up drastically due to the spraying and washing of the equipment, countertops and floors.

The run-time measurements 2800 may be used by the controller to adjust the default specifications 2700 to generate adjusted specifications 2900 shown in FIG. 29. The controller thus has the ability to adjust its own specifications according to its own run-time measurements. Once the adjusted specifications 2900 are defined by the controller, the controller can take steps to assure the various demands for treated water are met by the system. For example, when the deli is cleaned from 7-8 PM, the demand for water is relatively high at the water machine and the ice machine, and is very high in the deli. To meet these demands, the controller could start increasing the ozone concentration in the tank at 6:45 PM each day to satisfy the heavy demand in the deli. Of course, other adjustments and decisions are possible as well. The disclosure and claims herein extend to any suitable adjustment the controller can make based on the default specifications, run-time measurements, adjusted specifications, and detected conditions in the system 100.

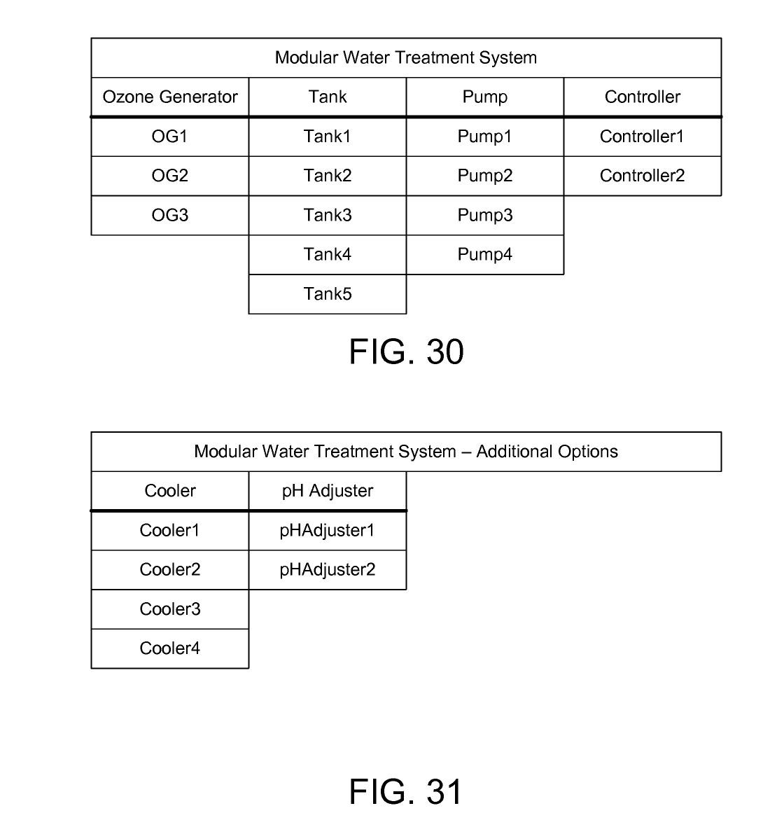

Ozone water treatment systems may need to be provided in a number of different sizes and capacities. One way to efficiently provide different systems that have different capabilities is to design a modular system for the water treatment system. A modular system provides different choices for each of the main components in the system. The modular system is designed so the connections between components is consistent. This allows the components to be assembled together in similar ways, which greatly simplifies production of different units that have different capabilities. For the example in FIG. 30, a modular water treatment system is defined that includes three different ozone generators OG1, OG2, and OG3; five different tanks Tank1, Tank2, Tank3, Tank4 and Tank5; four different pumps Pump1, Pump2, Pump3 and Pump4; and two different controllers Controller1 and Controller2. Additional modular components may include the water cooler and pH adjuster, as shown in FIG. 31. When a system is initially designed, one of each of the modular components is selected to provide the desired functionality. The modular components are then connected together to build the system. This modular approach has several benefits. First, the capabilities of the system can be customized according to the customer's needs. Second, should the specifications change, upgrading to other components is quite simple because the old one can be removed and a different one installed in a short period of time. Thirdly, maintainability is greater because any faulty piece can be easily replaced without affecting the other pieces. One suitable example is a skid-mounted ozone generation system that includes defined locations for the tank, ozone generator, pump and controller. Regardless of the customer's specifications, the completed system can be provided on a skid that has been customized to the customer's specifications while also providing the advantages of the modular system.

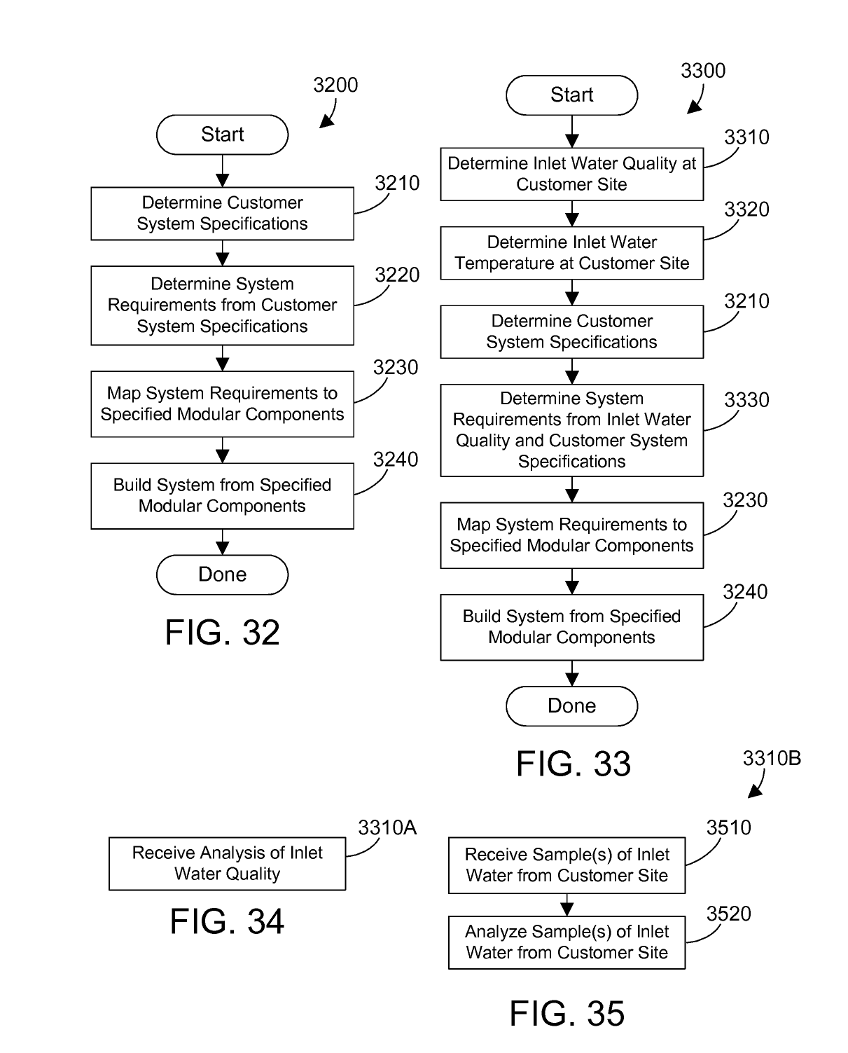

Referring to FIG. 32, a method 3200 for building a modular system begins by determining a customer's system specifications (step 3210). The system requirements are then determined from the customer's system specifications (step 3220). The system requirements are then mapped to specified modular components (step 3230). The system is then built from the specified modular components (step 3240), and method 3200 is done.

In addition to the customer system specifications, other factors may influence the design of the system, such as inlet water quality and inlet water temperature. Referring to FIG. 33, a method 3300 for building a customized modular system begins by determining the inlet water quality at a customer's site (step 3310). Then the inlet water temperature at the customer's site is determined (step 3320). Then the customer system specifications are determined (step 3210). From the information obtained from steps 3310, 3320, and 3330, the system specifications are determined (step 3330). The system requirements are then mapped to specified modular components (step 3230). The system is then built from the specified modular components (step 3240), and method 3200 is done. Method 3300 allows custom-designing the system according to the inlet water quality and temperature. For example, if the inlet water quality is low, or if the inlet temperature is high, a larger ozone generator may be needed.

Referring to FIGS. 34 and 35, methods 3310A and 3310B are two suitable implementations of step 3310 in FIG. 33. In FIG. 34, to determine water quality, an analysis of the inlet water quality is received (step 3320A in FIG. 34). For example, a sample of the water could be taken to a lab for analysis, with the lab providing the analysis of the water quality in step 3310A. In FIG. 35, to determine water quality, a sample or samples of inlet water are received from the customer's site (step 3510). The samples are then analyzed (step 3520), which could be done by a lab.

Other features could be incorporated into the water treatment system. For example, an overflow sensor could be placed on the tank to detect the unlikely event of the tank being overfilled. A drain line could be coupled to the tank through a solenoid valve to drain 116 in FIG. 1. If the overflow sensor detects the water in the tank reaches too high a level, the controller could activate the drain solenoid valve to prevent the tank from overflowing.

The water treatment system disclosed and claimed herein provides treated water that has a guaranteed threshold concentration of ozone at each exit point in the system. This is done by monitoring the ozone concentration in proximity to each exit point, and allowing water to exit at the exit point only when the ozone concentration in proximity to the exit point is above the threshold concentration of ozone.

One skilled in the art will appreciate that many variations are possible within the scope of the claims. While the examples herein are described in terms of time, these other types of thresholds are expressly intended to be included within the scope of the claims. Thus, while the disclosure is particularly shown and described above, it will be understood by those skilled in the art that these and other changes in form and details may be made therein without departing from the spirit and scope of the claims.

1. An apparatus comprising:
a tank having a water input port coupled to a water source, a treated water source port, and a treated water return port;
an ozone generator;
an ozone injection mechanism that injects ozone generated by the ozone generator into water flowing into the tank, thereby creating treated water in the tank;
a first ozone sensor that detects ozone concentration in the treated water in the tank;
a treated water pipe having a first pipe end coupled to the treated water source port, and a second pipe end coupled to the treated water return port;
an exit point on the treated water pipe where a portion of the treated water exits the apparatus;
a pump in line with the treated water pipe that pumps the treated water through the treated water pipe and provides output pressure sufficient to circulate the treated water from the tank through the treated water pipe and back to the tank, and to deliver the portion of the treated water that exits the apparatus at the exit point;
a second ozone sensor in proximity to the exit point that detects ozone concentration in the treated water in proximity to the exit point; and
a controller that receives signals from the first and second sensors, activates the pump, and allows water to exit the apparatus at the exit point only when the second ozone sensor detects ozone concentration in the treated water in proximity to the exit point above a predetermined threshold.

2. The apparatus of claim 1 further comprising an indicator in proximity to the exit point that indicates whether the treated water at the exit point has at least a threshold value of ozone concentration.

3. The apparatus of claim 1 wherein the first and second sensors are Oxidation-Reduction Potential (ORP) sensors.

4. The apparatus of claim 1 wherein the tank is a thermally insulated tank and further comprising a temperature sensor that detects temperature of the treated water in the insulated tank, a water cooler coupled to the insulated tank, and a cooling pump coupled to the water cooler and the insulated tank that circulates the water in the insulated tank through the water cooler and back to the insulated tank.

5. The apparatus of claim 1 further comprising a pH sensor that detects pH of the treated water in the tank, and a pH adjuster mechanism that changes pH of the treated water in the tank.

6. The apparatus of claim 1 further comprising an ozone gas sensor in a region above the treated water in the tank, and an ozone destructor coupled to the region above the treated water in the tank.

7. The apparatus of claim 1 wherein the pump provides a specified output pressure.

8. The apparatus of claim 1 wherein the controller does not allow the treated water to exit the apparatus at the exit point when the ozone concentration in the treated water in proximity to the exit point is not at least the threshold value of ozone concentration.

9. The apparatus of claim 1 further comprising:
a first valve coupled to the treated water pipe;
a third ozone sensor that measures ozone concentration in proximity to the first valve;
a second tank coupled to the first valve that receives the treated water from the first valve when the third ozone sensor detects the ozone concentration above a second threshold value;
a fourth ozone sensor in the second tank that measure ozone concentration in the treated water in the second tank;
a second valve coupled to the second tank;
wherein the treated water remains in the second tank until the fourth sensor detects ozone concentration in the treated water within the second tank has decreased to a third threshold value that is less than the second threshold value, and when the ozone concentration in the treated water within the second tank has decreased to below the third threshold value, the treated water in the second tank exits the system through the second valve.

10. A method for delivering water with at least a threshold ozone concentration to an exit point, the method comprising the steps of:
injecting ozone into water in a tank, thereby creating treated water;
monitoring ozone concentration of the treated water in the tank;
circulating the treated water through a loop having two ends coupled to the tank;
monitoring ozone concentration of the treated water in proximity to the exit point near the loop;
when the treated water in the tank has at least the threshold ozone concentration, pumping the treated water through the loop; and
when the treated water in proximity to the exit point has at least the threshold ozone concentration, and the treated water in the tank has at least the threshold ozone concentration, opening a valve to dispense a portion of the treated water in the loop at the exit point.

11. The method of claim 10 further comprising the step of:
when the treated water in proximity to the exit point has at least the threshold ozone concentration, providing an indication that the treated water in proximity to the exit point has at least the threshold ozone concentration.

12. The method of claim 10 wherein the steps of monitoring the ozone concentration of the treated water in the tank and monitoring the ozone concentration of the treated water in proximity to the exit point comprise measuring ozone concentration using Oxidation-Reduction Potential (ORP) sensors.

13. The method of claim 10 wherein the tank is a thermally insulated tank and further comprising the steps of:
measuring a temperature of the treated water in the insulated tank; and
when the temperature is above a temperature threshold, pumping the treated water from the insulated tank through a water cooler into the insulated tank.

14. The method of claim 10 further comprising the steps of:
measuring a pH of the treated water in the tank;
when the pH of the treated water in the tank is above a first threshold, adding a first pH adjuster to reduce the pH of the treated water in the tank; and
when the pH is below a second threshold, adding a second pH adjuster to increase the pH of the treated water in the tank.

15. The method of claim 10 further comprising the steps of:
measuring a concentration of ozone gas in air above a level of the treated water in the tank;
when the concentration of ozone gas exceeds a threshold, releasing the ozone gas into an ozone destructor; and
the ozone destructor destroying the released ozone gas.

16. The method of claim 10 further comprising the step of sending information to an external network.

17. The method of claim 10 wherein the pumping provides a specified output pressure that results in circulating the treated water in the loop.

18. The method of claim 10 wherein the portion of water is not dispensed when the ozone concentration in the treated water in proximity to the exit point is not at least the threshold value of ozone concentration.

19. The method of claim 10 further comprising the steps of:
a second tank receiving the treated water at the threshold level of ozone concentration;
monitoring ozone concentration of the treated water in the second tank; and
when the ozone concentration in the treated water in the second tank has dropped to below a second threshold, opening a valve to dispense a portion of the treated water in the second tank to the exit point.

20. A method for optimizing a controller in a system for providing ozone treated water, the method comprising the steps of:
enabling the controller with default specifications relating to times and flow rates for delivering the ozone treated water to a plurality of points of use;
monitoring run-time data as the system operates with the default specifications; and
automatically adjusting the controller specifications according to the run-time data.

21. The method of claim 20 further comprising the step of:
when the run-time data is outside a specified threshold, alerting a user.

22. A method for delivering a customized ozone water treatment system to a customer at a customer site, the method comprising the steps of:
(A) determining a water quality at the customer site;
(B) determining a water temperature at the customer site;
(C) determining customer specifications;
(D) determining system requirements from the items determined in steps (A), (B), and (C);
(E) mapping the system requirements to specified components from a list of modular components; and
(F) building the system from the specified components.

23. The method of claim 22 wherein step (A) comprises the step of determining the pH level of the water at the customer site.

24. The method of claim 22 further comprising the steps of:
selecting an ozone generator from the list of modular components;
selecting a tank from the list of modular components;
selecting a pump from the list of modular components; and
selecting a controller from the list of modular components.

25. An apparatus comprising:
an insulated tank comprising:
a water input port coupled to a source valve coupled to a filter coupled to a water source;
a treated water source port; and
a treated water return port;
an ozone generator;
an ozone injection mechanism that injects ozone generated by the ozone generator into water flowing into the tank, thereby creating treated water in the tank;
a first ozone sensor within the tank that detects ozone concentration in the treated water within the tank;
a treated water pipe having a first pipe end coupled to the treated water source port, and a second pipe end coupled to the treated water return port;
a plurality of exit point valves coupled to the treated water pipe where a portion of the treated water exits the apparatus;
a first pump in line with the treated water pipe that pumps the treated water through the treated water pipe and provides a specified output pressure sufficient to circulate the treated water in the treated water pipe and to deliver the portion of the treated water that exits the apparatus at the plurality of exit points;
a plurality of exit point ozone sensors in proximity to and corresponding to each of the plurality of exit points that each detects ozone concentration in the treated water in proximity to the corresponding exit point;
an indicator in proximity to each of the plurality of exit points that indicates when the treated water each exit point has at least the threshold value of ozone concentration;
a temperature sensor in the tank;
a water cooler coupled to the tank;
a cooling pump coupled to the water cooler and the tank that circulates the water in the tank through the water cooler and back to the tank;
a pH sensor in the tank that measures a pH of the treated water in the tank;
a pH adjuster mechanism that changes the pH of the water in the tank, the pH adjuster mechanism comprising a first pH adjuster that reduces the pH of the treated water in the tank and a second pH adjuster that increases the pH of the treated water in the tank;
an ozone gas sensor in a region above the treated water in the tank;
an ozone destructor coupled to the region above the treated water in the tank, wherein when a concentration of ozone gas exceeds a threshold, the ozone gas is released into the ozone destructor, and the ozone destructor destroys the released ozone gas;
a controller that receives signals from the first ozone sensor and from the plurality of exit point ozone sensors, activates the first pump, the cooling pump, the source valve, and the exit point valve, and outputs information from the apparatus to an external network, wherein the controller assures the ozone concentration at each point of use valve as detected by the corresponding point of use ozone sensor exceeds the threshold value before activating each point of use valve to dispense the treated water; and
a second pump that pumps the treated water through the ozone injection mechanism to circulate the treated water from the tank through the ozone injector and back to the tank.
